(19) United States
(12) Patent Application Publication
(10) Pub. No.: US 2014/0347429 A1
(43) Pub. Date: Nov. 27, 2014

(54) Inks

(71) Applicant: Sericol Limited, Kent (GB)

(72) Inventor: Nigel Gould, Kent (GB)

(73) Assignee: Sericol Limited, Kent (GB)

(21) Appl. No.: 14/367,300

(22) PCT Filed: Dec. 4, 2012
(86) PCT No.: PCT/GB2012/052997

§ 371 Date: Jun. 20, 2014

(30) Foreign Application Priority Data
Dec. 21, 2011 (GB) 1122030.8
Feb. 20, 2012 (GB) 1202831.2

(51) Int. Cl. C09D 11/101; C09D 11/36

(52) U.S. Cl. CPC C09D 11/101; C09D 11/36
USPC 347/100; 106/31.13; 106/31.6; 522/182; 522/181; 522/79

(57) ABSTRACT

An ink comprising a colorant, an organic solvent having a boiling point below 170° C. and a radiation-curable component of molecular weight >1000, wherein the ink contains less than 10 wt % of radiation-curable components of molecular weight 1000 or less and the ink contains less than 5 wt % water. The ink is particularly useful for printing packaging used for products intended for ingestion by humans or other animals.

This invention relates to inks and to a printing process, particularly for packaging used for products intended for ingestion by humans or other animals (“ingestible products”).

The packing industry has a high demand for inks and processes which can be used to make products attractive and convey relevant product information. Flexographic inks are widely used for this purpose. Such inks are usually unsuitable for use in ink jet printers because they are too viscous to fire from an ink jet printhead.

WO2011021052 describes a new ink jet printer and solvent-based, UV curable inks for use in the new printer. While the inks described in WO2011021052 are useful for conventional printing, this publication does not address the particular problems associated with the printing of packaging for ingestible products where ink migration through packaging could contaminate the product.

There exists a need for ink jet printable inks which are suitable for use on packaging used for products intended for ingestion by humans or other animals.

According to a first aspect of the present invention there is provided an ink comprising a colorant, an organic solvent having a boiling point below 170° C. and a radiation-curable component of molecular weight >1000, wherein the ink contains less than 10 wt % of radiation-curable components of molecular weight 1000 or less and the ink contains less than 5 wt % water.

In this specification (including its claims), the verb “comprise” and its conjugations is used in its non-limiting sense to mean that items following the word are included, but items not specifically mentioned are not excluded. In addition, reference to a feature by the indefinite article “a” or “an” does not exclude the possibility that more than one of the elements is present, unless the context clearly requires that there be one and only one of the elements. For example “having one” means having one and only one (not including two or more). The indefinite article “a” or “an” thus usually means “at least one”.

The ink preferably has a viscosity below 50 cP, more preferably below 40 cP, especially below 30 cP, particularly 5 to 25 cP, when measured at 25° C. Viscosities mentioned in this specification can be measured by any suitable technique, e.g. at 25° C. using a Brookfield DV-I viscometer operating at 30 revolutions per minute.

The ink preferably has a surface tension of 20 to 40, more preferably 20 to 35, especially 20 to 30 mN/m, when measured at 25° C.

Although it is not necessary for all of the ink components to be approved for use on food packaging (because the components may be registered for such use at a later date or the inks may be used for a purpose other than food packaging) for convenience it is preferred that all of the ink components are approved for use on food packaging.

The colorant is preferably a solvent-soluble dye or, more preferably, a pigment.

The pigment which can be used as colorant is not particularly limited, for example it can be an organic or inorganic pigment or a mixture thereof. Numerous commercially available pigments are listed in the Colour Index International.

Examples of colorants include but are not limited to (Color Index) Acid Blue 3; Acid Red 51; Acid Yellow 3 and 23; Disperse Yellow 54; Food Black 1 and 2; Food Blue 2; Food Brown 3; Food Red 3, 7, 9 and 17; Kaolinite; Natural Blue 1; Natural Red 4; Pigment Black 7; Pigment Blue 15, 15:1, 15:2, 15:3, 15:4, 15:6, 16, 27, 29 and 60; Pigment Green 7 and 37; Pigment Metal 1 and 2; Pigment Orange 5, 13, 16, 36, 43, 48:2, 48:3, 49:2, 52:1, 57:1, 61, 64, and 71; Pigment Red 2, 3, 4, 12, 101, 112, 144, 146, 149, 166, 170, 202, 208, 214, 220, 242 and 264; Pigment Violet 19, 23, 32 and 37; Pigment White 4, 5, 6, 7, 18, 19, 20, 21, 24, 25, 26 and 27; Pigment Yellow 1, 3, 4, 10, 13, 14, 16, 17, 42, 53, 62, 83, 93, 110, 128, 138, 139, 155, 180, 93 and 95; Solvent Violet 13; and titanium dioxide; and combinations of any two or more of the foregoing.

One will usually select a colorant which will not absorb all of the radiation used to cure the ink.

The colorant may be a single component or a combination of two or more components (e.g. 2 or more pigments).

When the colorant comprises a pigment the pigment preferably has an average particle size below 0.5 μm, more preferably below 0.3 μm. These particle size preferences provide storage stability advantages and have a lower tendency than larger particle sizes to block the fine nozzles of an ink jet printer. Typically the colorant is dispersed with the one or more other ingredients of the composition (especially with one or more dispersants) using a dispersing device, for example, a ball mill, a sand mill, an attritor, a roll mill, an agitator, a Henschel mixer, a colloid mill, an ultrasonic homogenizer, a pearl mill, a wet type jet mill, a paint shaker or the like.

Although the type of dispersant is not particularly limited, it is preferred to use a high-molecular weight dispersant (e.g. MWT >20,000) for dispersing pigments used in the inks of the present invention. Examples of suitable high-molecular weight dispersant include Efka™ 7701, Solsperse™ 24000 Solsperse™ 32000, Solsperse™ 33000, Solsperse™ 39000, Tegodisperse™ 685 and Disperbyk™ 168. It is also possible to use a synergist with the dispersant. In the present invention, the dispersant (when included) is preferably added in an amount of from 1 to 50 parts by weight per 100 parts by weight of colorant.

The colorant is preferably present in the ink in an amount of 0.25 to 20 wt %, preferably 0.5 to 10 wt %, more preferably 0.4 to 8 wt % and most preferably 0.5 to 5 % wt %, based on the total weight of the ink. The amount is referred to above is the amount of actual pigment, ignoring any other components of a pigment dispersion (e.g. the weight of any water, organic solvent, dispersant etc. is not included when calculating the wt % of pigment).

The organic solvent may be a single organic solvent or more than one organic solvent. Preferably the organic solvent has a boiling point below 155° C., more preferably below 140° C. Preferably all of the organic solvents present in the ink have a boiling point below 170° C., more preferably below 155° C., especially below 140° C. However small amounts of organic solvents having higher boiling points can be tolerated where the boiling point of the mixture of solvents as a whole (including any water present) is as defined for the present invention. For example, the solvents in the ink may form a positive azeotrope which has the presently claimed boiling point even though one or more of the organic solvents would have a higher boiling point when alone. The boiling point is of course the boiling point at 1.01325×10⁵ pascal (1 atmosphere). In view of the intended use of the inks, the organic solvent preferably has low toxicity and sufficient volatility to be removed from the ink quickly after the ink has been applied to a substrate. The organic solvent typically serves to reduce the viscosity of the ink and does not copolymerise with the curable components of the ink.

Preferably the organic solvent has a low viscosity (e.g. a viscosity of 1 to 6 cP, preferably 1 to 3 cP, when measured at 25° C.) because this can usefully reduce the viscosity of the ink as a whole to the levels which are preferred for the ink jet printing process.

Preferred organic solvents include alcohols, esters and glycol ethers and combinations of two or more of the foregoing. Preferred alcohols comprise 1 to 6 carbon atoms and one or two hydroxyl groups, especially C₁₋₄-monoalcohols (e.g. methanol, propanol and especially ethanol), C₂₋₆ diols (e.g. ethylene glycol, diethylene glycol, propylene glycol and dipropylene glycol) and Cₘ-glycol mono-ethers, e.g. of formula:

HO—CₘH₂ₘ—O(CₙH₂ₙ—O)ₚ—(C_{q}H_{2q+1})

wherein:

m is 2 to 4;

n is 2 to 4;

p is 0 or 1; and

q is 1 to 4.

Preferably m is 3. More preferably m is 3, p is 0 and q is 1.

The organic solvent is preferably present in the ink in an amount of at least 40 wt %, more preferably at least 45 wt %, and more preferably at least 50 wt %, for example 50 to 85 wt %, or 50 to 80 wt %, based on the total weight of the ink. In a particularly preferred embodiment the organic solvent is present in an amount of at least 55 wt %, for example 60 to 85 wt %, or 60 to 75 wt %, based on the total weight of the ink. When calculating the weight of organic solvent in the ink all sources of such solvent are added together, including any organic solvent present in other ink components, e.g. in a pigment dispersion, in radiation-curable components etc.

In one embodiment the ink comprises less than 10 wt % diethylene glycol diethyl ether, e.g. the ink is free from diethylene glycol diethyl ether. In another embodiment the ink comprises less than 10 wt % propylene carbonate, e.g. the ink is free from propylene carbonate.

It is difficult to completely eliminate water from the ink because some of the components used to make the ink may contain trace amounts of water and water may also be picked up from the atmosphere. However it is preferred that the ink is substantially free from water, e.g. it contains less than 1 wt % water.

The radiation-curable component of molecular weight (“MWT”) >1000 preferably has a MWT >1200, more preferably >1300. In one embodiment the radiation-curable component of molecular weight (“MWT”) >1000 preferably has a MWT <20,000, more preferably <10,000.

The MWT referred to in this specification is the weight average molecular weight.

Examples of radiation-curable components of MWT >1000 include EBECRYL™ LEO 10552 (an amine-modified polyether acrylate), EBECRYL™ LEO 10801, Genomer™ 3414 (a tetrafunctional polyether acrylate), Genomer™ 3364 (a trifunctional polyether acrylate), UVP 6505 (a tetra functional polyester acrylate), UVP 6600 (a hexa functional polyester acrylate), Ebecryl™ 10552 (an amine modified polyester acrylate 3.5 functional) and Ebecryl™ 10801 (a hexafunctional polyester acrylate).

Preferably the radiation-curable component of MWT >1000 comprises a radiation curable oligomer. Preferred radiation curable oligomers suitable for use in the present invention comprise a backbone, for example a polyester, urethane, epoxy or polyether backbone, and one or more ethylenically unsaturated groups. The ethylenically unsaturated groups can be any group capable of polymerising upon exposure to radiation.

Preferably the radiation-curable component of MWT >1000 is approved for use on food packaging. Such radiation-curable components include polyester polyacrylates of MW 1,100 to 3000 (e.g. Ebecryl™ LEO 10801, a polyester hexaacrylate of MW 1,500) and the Ebecryl™ products listed above. The radiation-curable component of MWT >1000 is preferably present in the ink in an amount of 2% to 65 wt %, more preferably 2 to 45 wt %, more preferably 5 to 35 wt %, based on the total weight of the ink.

Small amounts, e.g. up to 10 wt %, of radiation-curable components of molecular weight 1000 or less can be tolerated in the ink. Preferably some or more preferably all of the radiation-curable components of molecular weight 1000 (when present) have at least two, more preferably 2, 3, 4, 5 or 6 ethylenically unsaturated groups, because such multi-functional monomers copolymerise more effectively than monofunctional monomers and are less likely to migrate through packaging. Preferably however the ink comprises less than 5 wt % of radiation-curable components of molecular weight 1000 or less and even more preferably the ink is free from such components.

The low (or zero) content of radiation-curable components of molecular weight 1000 or less is useful to provide a print having low migration characteristics, even if it is not fully cured.

Preferably the ink is free from monofunctional (meth)acrylates.

Suitable multifunctional (meth)acrylate monomers also include esters of methacrylic acid (i.e. methacrylates), such as hexanediol dimethacrylate, trimethylolpropane trimethacrylate, triethyleneglycol dimethacrylate, diethyleneglycol dimethacrylate, ethyleneglycol dimethacrylate, 1,4-butanediol dimethacrylate. Mixtures of (meth)acrylates may also be used.

(Meth)acrylate is intended herein to have its standard meaning, i.e. acrylate or methacrylate. Mono- and multifunctional are also intended to have their standard meanings, i.e. one and two or more ethylenically unsaturated groups, respectively, which take part in the polymerisation reaction on curing. When UV light is used to cure the cure the ink, the ink preferably contains one or more photoinitiators. Whilst any commercially photoinitiators can be used which matches the radiation.

When the ink is intended for use on packaging for ingestible products, the photoinitiator is preferably a non-toxic photoinitiator which does not give rise to toxic materials when irradiated. Thus the photoinitiator preferably has a low or no ability to migrate through the substrate upon which the ink will subsequently be printed.

The photoinitiator(s) preferably have a low tendency to migrate through packaging. Examples of such low migration photoinitiators include Esacure™ 1001M, Genopol™ AB-1, Genopol™ BP-1, Genopol™ TX-1, Omnipol™ 100F, Omnipol™ 910, Omnipol™ 1001, Omnipol™ ASA, Omnipol™ BP, Omnipol™ TX, Ebecryl™ P39, Speedcure™ 7005, Speedcure™ 7006, Speedcure™ 7010, Speedcure™ 7040 and especially Irgacure™ 819 and Irgacure™ 369 due to their low tendency to migrate through packaging.

Examples of photoinitiators include but are not limited to: 2-benzoyl benzoic acid, methyl ester; poly(ethylene glycol) bis(p-dimethylaminobenzoate) phosphine oxide, diphenyl(2,4,6-trimethylbenzoyl)-; 4-Isopropyl thioxanthone; phenyl bis(2,4,6-trimethylbenzoyl) phosphine oxide; benzene, (1 -methylethenyl)-, homopolymer, ar-(2-hydroxy-2-methyl-1-oxopropyl) derivs.; mixture of oxy-phenyl-acetic acid 2-[2-oxo-2-phenylacetoxy-ethoxy]-ethyl ester and oxy-phenyl-acetic 2-[2-hydroxy-ethoxy]-ethyl ester; poly[oxy(methyl-12-ethandiyl)], alpha-[4-(dimethylamino) benzoyl-omega-butoxy; 1-(4-[(4-benzoylphenyl)thio]phenyl)-2-methyl-2-[(4-methylphenyl)sulfonyl]-1-propan-1-one; 2-hydroxy-1-(4-(4-(2-hydroxy-2-methylpropionyl)benzyl)phenyl-2-methyl-2-propanone; di-ester of carboxymethoxy benzophenone and polytetramethyleneglycol 250; di-ester of carboxymethoxy-benzophenone and polyethylene glycol 200; poly(oxy-1,4-butanediyl), .alpha.-[2-[(9-oxo-9Hthioxanthenyl)oxy]acetyl]-.omega.-[[2-[(9-oxo-9Hthioxanthenyl)oxy]acetyl]oxy]-; (dimethylamino)benzoate, esters with branched polyols; (methylamino)diethane-2,1-diylbis(4-dimethylamino amino benzoate); 9-Oxo-9H-thioxanthene-carboxylate, esters with branched polyols; and benzoylbenzoate, esters with branched polyols; and combinations of any two or more of the foregoing. Preferably the ink components (including the photoinitiator(s)) are selected such that when the ink is cured, no more than 50 parts per billion of extractable unidentified material with no individual unidentified material being present at greater than 10 parts per billion. The amount of extractable material may be determined as follows. The ink is applied to a substrate and cured. A known area of the reverse side of the printed substrate (i.e. the non-printed side of the substrate) is exposed to a pre-determined volume of food simulant (e.g. 50 wt % solution of ethanol in deionised water) for 10 days at 40° C. This is to look at the materials migrating through the substrate from the ink and to also include any materials that have offset when the printed roll is stored before use. The simulant is then analysed by HPLC and the concentration of extracted materials per unit area is calculated to determine the parts per billion of extractable material, their identity (where possible) and the amount of each extractable material.

Preferred photoinitiators include alpha-hydroxycarbonyl derivatives of a dimers or trimers of alpha-methylstyrene. Such photoinitiators are described in, for instance, WO02085832 and U.S. Pat. No. 4,987,159. Commercially available photoinitiators of this type include Esacure™ 1 and Esacure™ KIP 60, available from Lamberti.

Preferably the photoinitiator has at least two photopolymerisable groups.

Preferably all photoinitiators present in the ink have a molecular weight >1000. This preference arises because such photoinitiators have a low tendency to migrate through packaging.

Examples of commercially available photoinitiators having a molecular weight >1000 include Esacure™ 1000M (available from Lamberti) and Speedcure™ 7040 (available form Lambsons). Both of these materials are Norrish type II photoinitiators and, as such, when used in an ink according to the present invention the ink preferably also contains a photosynergist, especially a photosynergist having a molecular weight >1000. An example of a suitable photosynergist is Speedcure™ 7040 (an polymeric amine synergist with a molecular weight of 1039 availalble from Lambsons).

The inks of the present invention can be used to provide prints having a very thin film thickness. This is advantageous because it means there are less print materials on the packaging and therefore less cured ink available to permeate through the packaging, thereby reducing the chance of undesirable levels of contamination.

The ink preferably comprises photoinitiator in an amount of 0 to 20 wt %, more preferably 0 to 10 wt %, especially 1 to 8 wt %, based on the total weight of the ink. It is not essential for the ink to contain a photoinitiator, for example when the ink is to be cured using an electron beam no photoinitiator is necessary.

Additionally the ink may contain further ingredients, e.g. a stabilizer, wax, preservative, viscosity modifier, stabiliser, dispersing agent, inhibitor, antifoam agent, anionic, cationic, non-ionic and/or amphoteric surfactant (especially those having a MWT >1,000, e.g. Byk™ 331) and the like in accordance with the object to be achieved.

In view of the foregoing, a preferred ink according to the first aspect of the present invention comprises:
(a) 0.25 to 20 wt % of colorant;
(b) at least 40 wt % of organic solvent having a boiling point below 170° C.;
(c) 2 to 65 wt % of radiation-curable component of molecular weight >1000;
(d) 0 to 20 wt % photoinitiator; and
(e) less than 10 wt % of radiation-curable components of molecular weight 1000 or less.

A particularly preferred ink comprises:
(a) 0.5 to 5 wt % of colorant;
(b) 60 to 75 wt % of organic solvent having a boiling point below 140° C.;
(c) 10 to 35 wt % of radiation-curable component of molecular weight >1000;
(d) 1 to 10 wt % (e.g. 1 to 8 wt %) photoinitiator; and
(e) less than 5 wt % of radiation-curable components of molecular weight 1000 or less.

The abovementioned preferred and particularly preferred inks of the present invention also contain less than 5 wt % water. Other preferences for these preferred inks (e.g. viscosity, surface tension, water content etc.) are as described above.

A second aspect of the present invention provides a process for printing a substrate comprising applying thereto an ink according to the first aspect of the present invention by means of an ink jet printer and curing the ink.

The ink jet printer may be, for example, a thermal, piezo or paddle-type ink jet printer. Thermal printheads are commonly used in HP and Canon printers, while piezo printheads are common in Epson printers. Paddle-type printers are disclosed in the numerous patents filed by Silverbrook.

In order to maximise image quality, and control bleed and feathering between image areas it is preferable to arrest the flow of the ink quickly after it has impacted on the substrate surface, a process often referred to as ‘pinning’. To achieve a good quality image it is preferable that the inks are ‘pinned’ either thermally or by irradiation, that is heated (in order to evaporate some or all of the organic solvent) and/or irradiated, within 5 seconds of impact, preferably within 1 second and most preferably within 0.5 seconds. Thus the process optionally comprises the additional step of evaporating at least a part of the organic solvent from the ink before, during or after curing the ink.

The optional step of evaporating at least a part of the organic solvent from the ink before, during or after curing the ink is preferably performed at a temperature in the range 45 to 110° C., more preferably 50 to 100° C.

The evaporation step, when performed, is preferably performed for from 0.5 to 10 minutes, more preferably 0.5 to 5 minutes, especially 0.5 to 3 minutes, depending on the temperature used, the amount of organic solvent to be evaporated and the volatility of the organic solvent.

Any means that is suitable for evaporating solvent from the ink can be used in the process and apparatus of the invention. Examples include dryers, heaters, air knives and combinations thereof.

In one embodiment, the solvent is evaporated by heating. Heat may be applied to either side or both sides of the substrate, for example by the use of heated plates (resistive heaters, inductive heaters) provided on the opposite side of the substrate to the image or radiant heaters (heater bars, IR lamps, solid state IR) provided on the same side as the printed image.

Preferably a significant portion of the organic solvent is evaporated from the composition before the ink is radiation-cured. Preferably at least 50%, or more preferably substantially all, of the organic solvent is evaporated before the ink is radiation-cured.

Preferably the curing is performed by a process comprising irradiating the ink, for example with ultra-violet light or an electron beam.

In one embodiment a radiation source is positioned downstream from a means for evaporating solvent from the transparent composition. In other words an evaporating means and a radiation source are positioned so that printed substrate is exposed to the means for evaporating solvent before it is exposed to radiation, allowing evaporation of the at least some (and preferably most or all) of the organic solvent from the ink before the ink is radiation-cured.

The source of radiation may be any source which provides the wavelength and intensity of radiation necessary to cure the ink.

The identity of the image is not critical to the present invention. For example, the image may be text, numbers, a picture or a combination of two or more thereof. The image may cover all or just a part of the substrate and may be any colour or combination of colours.

According to a third aspect of the present invention there is provided a ink jet printer comprising an ink according to the first aspect of the present invention.

The invention is illustrated by the following non-limiting examples in which all parts are by weight unless specified otherwise.

The following abbreviations are used in the Examples:
Irgalite™ blue GLVO is a phthalocyanine pigment obtained from BASF.
Ebecryl™ LEO 10801 is a polyester hexacrylate of MW 1,500 obtained from Cytec.
Dowanol™ PM is the mono methyl ether of propylene glycol, obtained from Dow chemicals.
Disperbyk™ 168 is a dispersant of MW of 37,000, obtained from Byk chemie. Irgalite™ blue GLVO is a phthalocyanine pigment, obtained from BASF.
BYK™ 331 is a polyether modified polydimethylsiloxane surfactant having a NAMW>1000, obtained from Byk Chemi.
Irgacure™ 819 is a bis acylphosphine oxide photoinitiator, obtained from BASF.
Genomer™ 3497 is a modified polyether polyol acrylate having four acrylate groups and a molecular weight of 2000 (obtained from Rahn USA Corp).
Rapicure™ DVE3 is a vinyl ether monomer having the following structure:

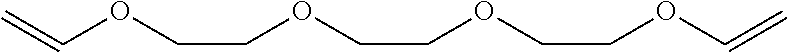

### EXAMPLE 1

### Stage i) Preparation of Pigment Dispersion

A pigment dispersion was prepared by dispersing a mixture comprising Irgalite™ blue GLVO (30 parts), Disperbyk™ 168 (20 parts) and Rapicure DVE3 (50 parts) in a dispermat until the DV90 for particle size had reached 0.4 microns. The resultant pigment dispersion was 30 wt % pigment.

### Stage ii) Ink Preparation

The components shown in Table 1 below were mixed together in a Silverson™ mixer LVR until fully homogenous. The viscosity of the resultant ink at 25° C. was 12.4 cP, as measured by a Brookfield DV-I viscometer @30 rpm, 25° C.

TABLE 1

| | Example 1 - Ink 1 | Example 2 - Ink 2 |
|---|---|---|
| Component description | (parts by weight) | (parts by weight) |
| Radiation-curable | Ebecryl ™ | Genomer ™ 3497 |
| monomer of | LEO 10801 | (31.5) |
| MWT >1000 | (29.0) | |
| Organic solvent | Dowanol ™ PM | Dowanol ™ PM |
| | (60.9) | (58.4) |
| Colorant | Cyan pigment | Cyan pigment |
| | dispersion* | dispersion* |
| | (6.0) | (6.0) |
| Dispersant | Byk ™331 | Byk ™331 |
| | (0.1) | (0.1) |
| Photoinitiator | Irgacure ™ 819 | Irgacure ™ 819 |
| | (4.0) | (4.0) |

Note
*the pigment dispersion was prepared as described above in Example 1, stage i). The pigment dispersion comprised a dispersant and so was less than 100% pigment. The pigment content of the pigment dispersion was 30 wt % and hence the actual number of parts of colorant was (30% × 6.0) = 1.8 parts by weight.

### Results

The ink described in Table 1 above was drawn down to form a film on a clear polyvinyl chloride substrate (220 μm thickness, from Genotherm) using a 12 micron K bar applicator. The resultant film was oven dried for three minutes at 60° C. and then conveyed at a speed of 25 m/min under a UV drier fitted with one 120 W/cm medium pressure mercury lamp. The properties of the resultant film were then assessed as follows and the results are shown in Table 2 below:
Solvent resistance—each test sample was rubbed with a soft cloth impregnated with isopropyl alcohol, the number of double rubs being taken to remove the image was noted.
Water resistance—each test sample was rubbed with a soft cloth impregnated with water, the number of double rubs being taken to remove the image was noted.
Adhesion—3M scotch tape was securely applied to each test sample and removed with a sharp tug. The degree of image removal was scored 1 for complete image removal and 5 for no visible image removal.

TABLE 2

| | Solvent | Water | |
|---|---|---|---|
| Sample | resistance | resistance | Adhesion |
| Example 1 - Ink 1 | >100 | >100 | 5 |
| Example 2 - Ink 2 | >100 | >100 | 5 |

1. An ink comprising a colorant, an organic solvent having a boiling point below 170° C. and a radiation-curable component of molecular weight >1000, wherein (i) the ink contains less than 10 wt % of radiation-curable components of molecular weight 1000 or less; and (ii) the ink contains less than 5 wt % water and (iii) the ink has a viscosity of 5 to 25 cP, when measured at 25° C.

2. (canceled)

3. An ink according to claim 1 which further comprises a photoinitiator.

4. An ink according to claim 1 wherein all of the ink components are approved for use on food packaging.

5. An ink according to claim 1 wherein the radiation-curable component of molecular weight >1000 is or comprises a polyester polyacrylate of molecular weight 1,100 to 3000.

6. An ink according to claim 1 which comprises:
(a) 0.25 to 20 wt % of colorant;
(b) at least 40 wt % of organic solvent having a boiling point below 170° C.;
(c) 2 to 65 wt % of radiation-curable component of molecular weight >1000;
(d) 0 to 20 wt % photoinitiator; and
(e) less than 10 wt % of radiation-curable components of molecular weight 1000 or less.

7. An ink according to claim 1 which comprises:
(a) 0.5 to 5 wt % of colorant;
(b) 60 to 75 wt % of organic solvent having a boiling point below 140° C.;
(c) 10 to 35 wt % of radiation-curable component of molecular weight >1000;
(d) 1 to 10 wt % photoinitiator; and
(e) less than 5 wt % of radiation-curable components of molecular weight 1000 or less.

8. An ink according to claim 1 wherein all of the radiation-curable components of molecular weight 1000 or less present in the ink have at least two ethylenically unsaturated groups.

9. An ink according to claim 1 which is free from radiation-curable components of molecular weight 1000 or less.

10. An ink according to claim 1 wherein the colorant comprises a pigment.

11. An ink according to claim 1 wherein the organic solvent is or comprises the mono methyl ether of propylene glycol.

12. An ink according to claim 1 wherein the organic solvent is or comprises ethanol.

13. An ink according to claim 1 wherein the organic solvent is or comprises ethyl acetate.

14. (canceled)

15. (canceled)

16. A process for printing a substrate comprising applying thereto an ink according to claim 1 by means of an ink jet printer and curing the ink.

17. A process according to claim 16 wherein the curing is performed by a process comprising irradiating the ink with ultra-violet light.

18. (canceled)

19. An ink according to claim 6 which is free from radiation-curable components of molecular weight 1000 or less.

20. An ink according to claim 7 which is free from radiation-curable components of molecular weight 1000 or less.

21. An ink according to claim 6 wherein the organic solvent is or comprises the mono methyl ether of propylene glycol, ethanol or ethyl acetate and the colorant comprises a pigment.

22. A process for printing a substrate comprising applying thereto an ink according to claim 6 by means of an ink jet printer and curing the ink.

23. A process according to claim 22 wherein the curing is performed by a process comprising irradiating the ink with ultra-violet light.
